(19) United States
(12) Patent Application Publication
(10) Pub. No.: US 2008/0304253 A1
(43) Pub. Date: Dec. 11, 2008

(54) LIGHTED HANDRAIL

(75) Inventor: Jerrold Handsaker, Roland, IA (US)

Correspondence Address: BRIGGS AND MORGAN P.A., 2200 IDS CENTER, 80 SOUTH 8TH ST, MINNEAPOLIS, MN, 55402, US

(73) Assignee: Innovative Lighting, Inc., Roland, IA (US)

(21) Appl. No.: 12/049,554

(22) Filed: Mar. 17, 2008

Related U.S. Application Data
(60) Provisional application No. 60/918,393, filed on Mar. 16, 2007.

(51) Int. Cl. F21S 8/00

(52) U.S. Cl. 362/146

(57) ABSTRACT

A lighted handrail system is provided comprising in its basic form a handrail, a light source, and a power source. Preferably, the handrail has an opening adapted to receive the light source.

### CROSS-REFERENCE TO RELATED APPLICATION

The present application claims priority to and incorporates herein, U.S. Provisional Patent No. 60/918,393 filed on Mar. 16, 2007.

### BACKGROUND OF THE INVENTION

1. Field

The present invention relates to a lighted handrail. In particular, the invention relates to a handrail that includes a light source in order to illuminate stairs or other walkways.

2. Background

Dark or poorly illuminated stairways and walkways are hazardous. Mechanisms for illuminating stairways and walkways are well known in the art. Wall mounted fixtures can be used, as well as ceiling lights. Wall-mounted and ceiling lights require installation, holes in the walls or ceiling, and electrical wiring run to the fixtures. In order to adequately light the walkway or stairs, several fixtures often are required. Also, these lights, especially ceiling lights, generally produce unattractive or harsh light that is visually unappealing.

Another way of lighting stairways is to install lights directly into the steps. While this ensures that each step is lighted, built-in lighting systems typically cannot be installed on conventional stairs. Installation can also result in bumps on the steps that create an additional danger.

Thus, a need exists for an improved system for lighting stairways and walkways.

### SUMMARY OF THE INVENTION

An object of the present invention is to provide a system for lighting stairways and walkways.

These and other objects of the present invention will become apparent to those skilled in the art upon reference to the following specification, drawings, and claims.

The present invention intends to overcome the difficulties encountered heretofore. To that end a lighted handrail system is provided. The handrail system includes handrail, a light source adapted to attach to the handrail and an electrical means for powering the system.

### BRIEF DESCRIPTION OF THE DRAWINGS

FIG. 1 is a cross section of the handrail of the present invention.

FIG. 2 is a perspective view of a cross section of the handrail of the present invention.

FIG. 3 is a typical handrail.

FIG. 4 is a view of a section of rope light of the present invention.

FIG. 5 is a channel light adapted to attach to the handrail of the present invention.

### DETAILED DESCRIPTION OF THE INVENTION

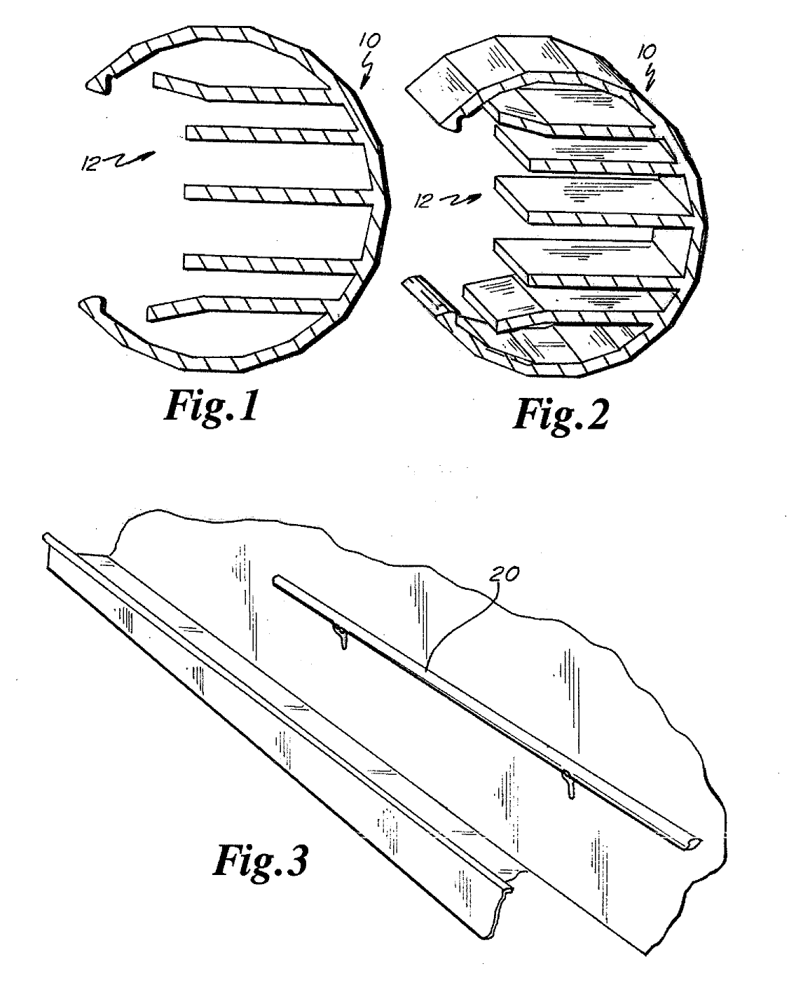

Illustrated in FIGS. 1 and 2 is a handrail 10 with an opening 12 to receive a light source. The light source generally extends substantially the length of the handrail. The light source is powered by an electrical means.

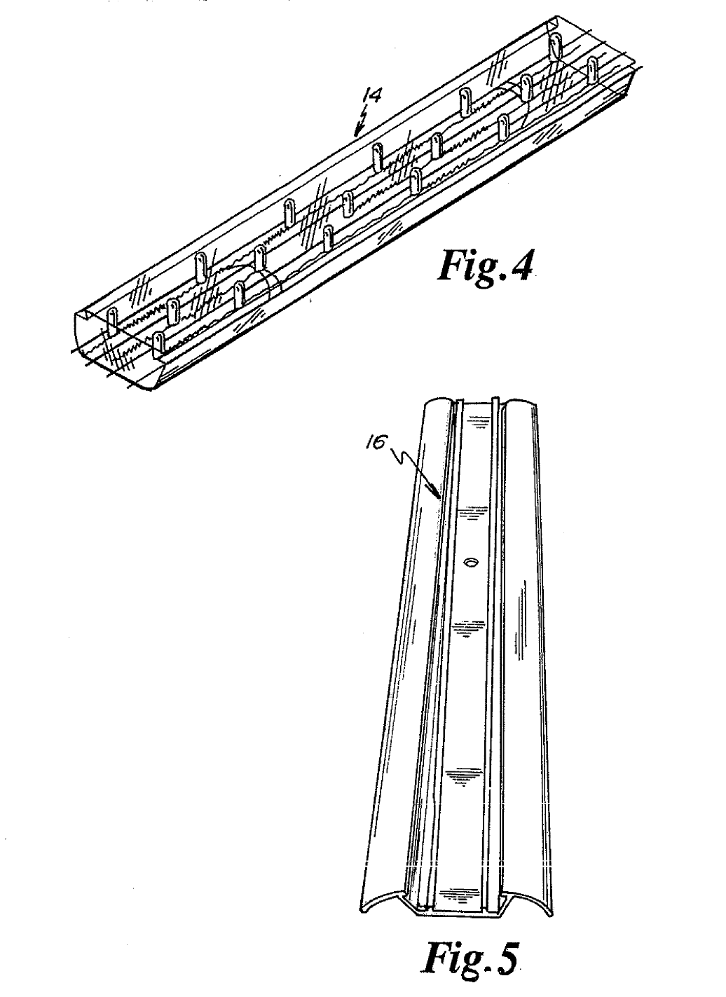

In one embodiment, the light source is a rope light 14 of the type shown in FIG. 4. The rope light 14 is comprised of a flexible material generally in a tubular form of the general size and shape of the opening 12 of the handrail. Small lights are embedded in the material along with narrow electrical connectors. Preferably, the rope light 14 is comprised of light emitting diodes (LED) lights. The material itself can be clear or colored, and in the case of LED lights, the lights can be different colors. The number of lights can vary not only by the number of lights on a string, but also the number of strings within the rope 14. Other types of lights could also be used in this invention, including strings of lights or individual lights inserted along the handrail 10.

In another embodiment, the rope light 14 is housed in a separate channel member 16, as shown in FIG. 5. The channel member 16 and rope light 14 feature matingly aligned profiles to form an interlocking connection when the rope light 14 is inserted into the channel 16. The channel member 16 with the rope light 14 is received by the opening 12 of the handrail 10, or is otherwise attached to the handrail 10.

The handrail 10 may be made from metal or wood, and the like.

In one embodiment, the handrail 10 has an opening 12 to receive the light source (FIGS. 1-2). The handrail includes a plurality of internal baffles that provide internal support as well a creating surface features to retain the light 14 and/or channel 16. Furthermore, the open structure of the handrail 10 allows for easily attaching any wires or electrical connectors that would be needed to electrify the light 16.

In another embodiment, the handrail 20 does not have an opening for the light source (FIG. 3). The light 14 and/or channel 16 are attached to the handrail 20 using an attachment means, such as glue or two-sided tape. The light 14 or channel 16 is generally attached to the handrail 20 or received by the handrail 10 on the underside of the handrail, or on the stair side of the handrail to best illuminate the stairway or walkway.

The handrail 10 substantially eliminates the problems of the prior art. The system allows for the use of high efficiency lighting, reduces the dangers of dark stairways and walkways, and does not require installation of a series of light fixtures.

The foregoing description and drawings comprise illustrative embodiments of the present inventions. The foregoing embodiments and the methods described herein may vary based on the ability, experience, and preference of those skilled in the art. Merely listing the steps of the method in a certain order does not constitute any limitation on the order of the steps of the method. The foregoing description and drawings merely explain and illustrate the invention, and the invention is not limited thereto, except insofar as the claims are so limited. Those skilled in the art who have the disclosure before them will be able to make modifications and variations therein without departing from the scope of the invention.

What is claimed is:

1. An illuminated handrail system, comprising:
a) a handrail;
b) a light source adapted to attach to the handrail; and
c) an electrical means for powering said light source.

2. The illuminated handrail system of claim 1, wherein the handrail has an opening adapted to receive the light source.

3. The illuminated handrail system of claim 1, wherein the light source is a rope light extending substantially the length of the handrail.

4. The illuminated handrail system of claim 1, wherein the rope light is comprised of light emitting diodes.

5. The illuminated handrail system of claim 3, wherein the rope light is secured within a channel for mounting on the handrail.

6. The illuminated handrail system of claim 5, wherein handrail has an opening adapted to receive the channel.

7. The illuminated handrail system of claim 2, wherein the opening is directed downward.

8. The illuminated handrail system of claim 1, wherein the handrail is metal.

9. The illuminated handrail system of claim 1, wherein the handrail is wooden.

10. The illuminated handrail system of claim 1, wherein the handrail includes a plurality of internal baffles for support and retention of said light source

11. A method of illuminating a stairway, the steps comprising:
a) providing a handrail;
b) attaching a light source to the handrail;
c) providing an electrical means for powering the light source.

12. The method of claim 11, wherein the handrail has an opening adapted to receive the light source.
